(19) United States
(12) Patent Application Publication
(10) Pub. No.: US 2020/0331331 A1
(43) Pub. Date: Oct. 22, 2020

(54) Trunk Mounted Retractable Sunshade Assembly

(71) Applicant: Andrew Houston, Marietta, GA (US)

(72) Inventor: Andrew Houston, Marietta, GA (US)

(21) Appl. No.: 16/387,612

(22) Filed: Apr. 18, 2019

(51) Int. Cl. B60J 11/02

(52) U.S. Cl. CPC B60J 11/025

(57) ABSTRACT

A trunk mounted retractable sunshade assembly for protecting a vehicle from weather conditions and high temperatures includes a pair of straps and a shading module. Each strap has a first end that configured to couple to an inner surface of a trunk of a vehicle, proximate to both a rear and a respective opposing side of the vehicle. Each of opposing endpoints of the shading module is coupled to a second end of a respective strap. The straps are configured to be extended from the trunk so that the shading module is selectively positionable externally to the trunk with the trunk closed. The shading module is spring-loaded so that a center panel of the shading module is selectively extendable to cover at least a portion of an upper surface of the vehicle to protect the portion of the upper surface of the vehicle from weather conditions and sunlight.

### CROSS-REFERENCE TO RELATED APPLICATIONS

### Statement Regarding Federally Sponsored Research or Development

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to sunshade assemblies and more particularly pertains to a new sunshade assembly for protecting a vehicle from weather conditions and high temperatures.

### BRIEF SUMMARY OF THE INVENTION

An embodiment of the disclosure meets the needs presented above by generally comprising a pair of straps and a shading module. Each strap has a first end that configured to couple to an inner surface of a trunk of a vehicle, proximate to both a rear of the vehicle and a respective opposing side of the vehicle. Each of opposing endpoints of the shading module is coupled to a second end of a respective strap. The straps are configured to be extended from the trunk so that the shading module is selectively positionable externally to the trunk with the trunk closed. The shading module is spring-loaded so that a center panel of the shading module is selectively extendable. The center panel is configured to cover at least a portion of an upper surface of the vehicle to protect the portion of the upper surface of the vehicle from weather conditions and sunlight.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a trunk mounted retractable sunshade assembly according to an embodiment of the disclosure.

FIG. 2 is a detail isometric perspective view of an embodiment of the disclosure.

FIG. 3 is an in-use view of an embodiment of the disclosure.

FIG. 4 is an in-use view of an embodiment of the disclosure.

FIG. 5 is an in-use view of an embodiment of the disclosure.

FIG. 6 is a rear view of an embodiment of the disclosure.

FIG. 7 is a rear view of an embodiment of the disclosure.

FIG. 8 is a rear view of an embodiment of the disclosure.

FIG. 9 is a rear view of an embodiment of the disclosure.

FIG. 10 is a top view of an embodiment of the disclosure.

### DETAILED DESCRIPTION OF THE INVENTION

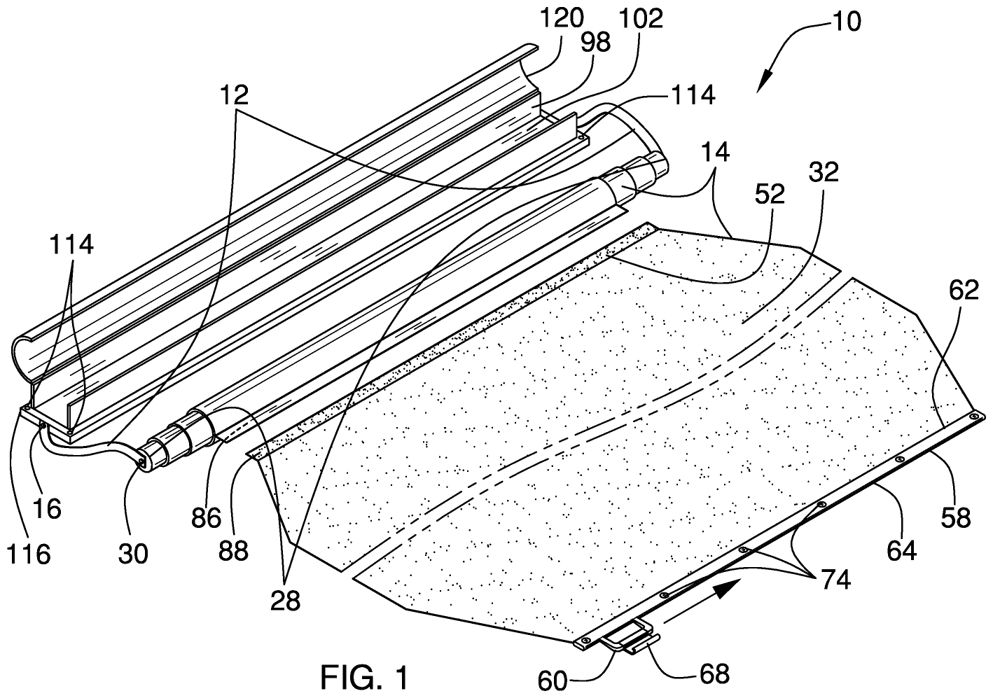

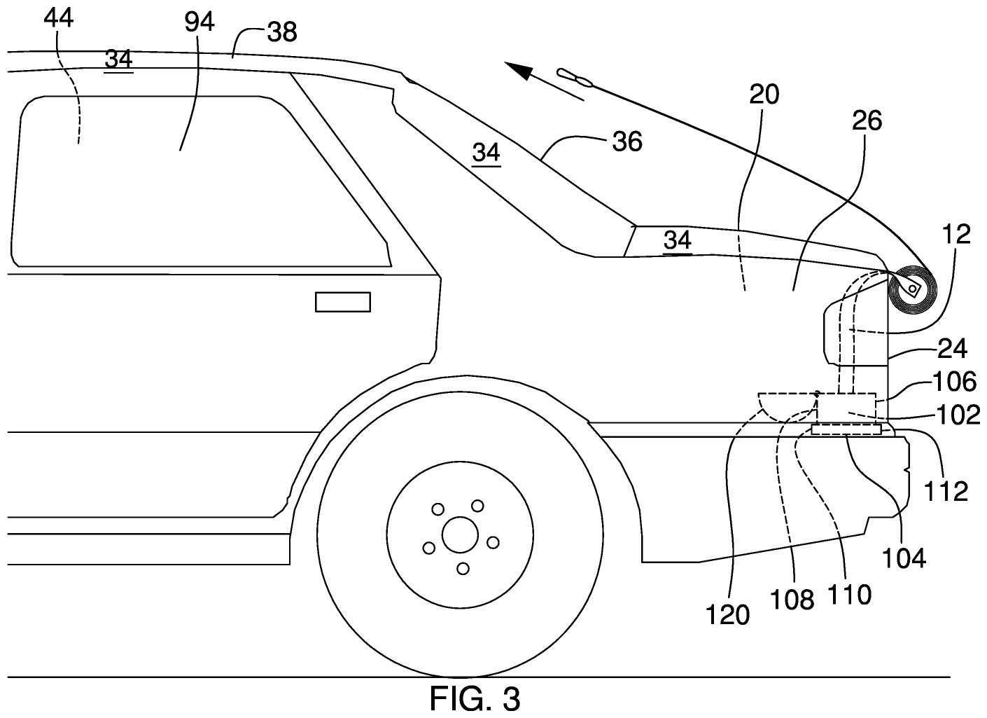

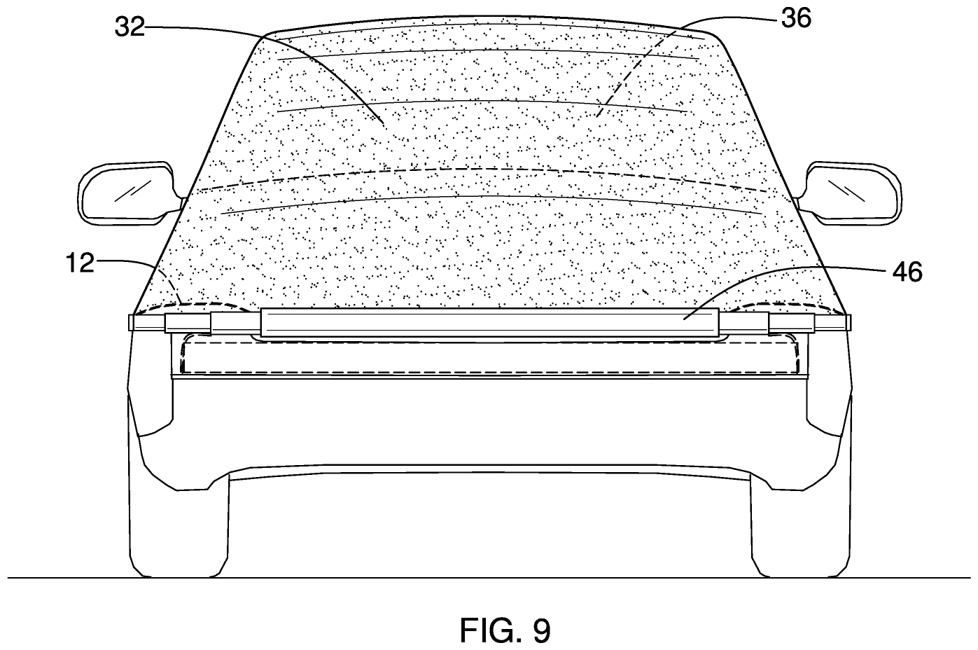

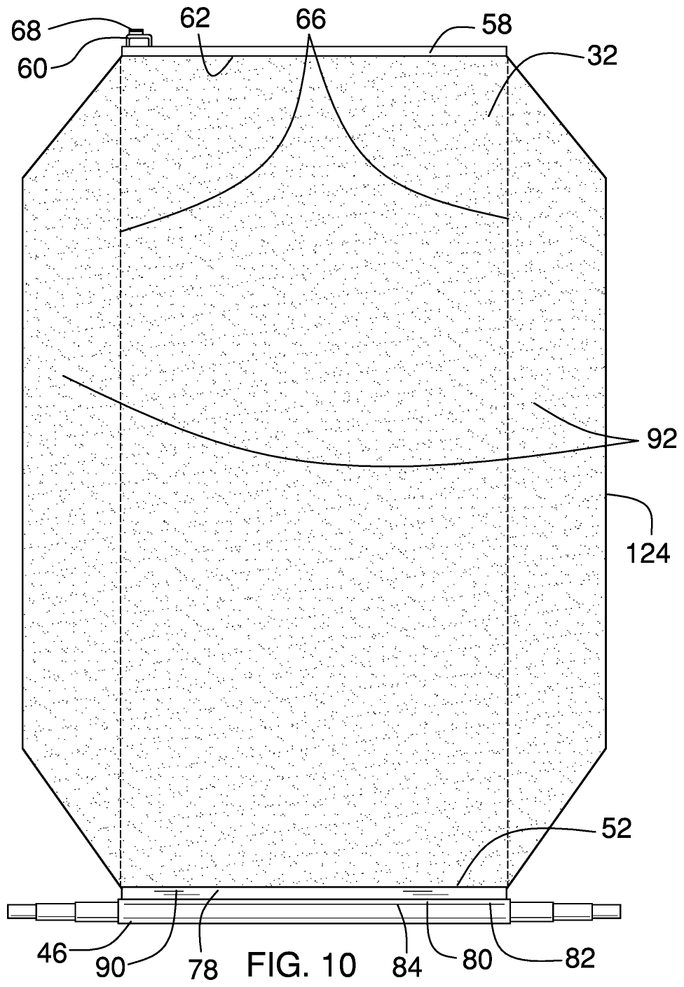

With reference now to the drawings, and in particular to FIGS. 1 through 10 thereof, a new sunshade assembly embodying the principles and concepts of an embodiment of the disclosure and generally designated by the reference numeral 10 will be described.

As best illustrated in FIGS. 1 through 10, the trunk mounted retractable sunshade assembly 10 generally comprises a pair of straps 12 and a shading module 14. Each strap 12 has a first end 16 that configured to couple to an inner surface 18 of a trunk 20 of a vehicle 22 proximate to both a rear 24 of the vehicle 22 and a respective opposing side 26 of the vehicle 22.

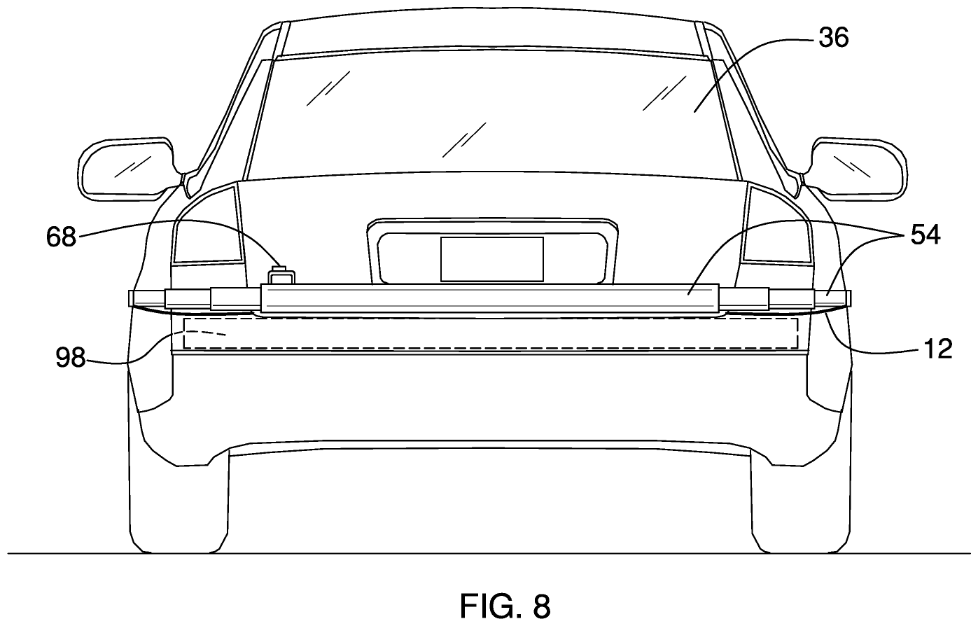

Each opposing endpoint 28 of the shading module 14 is coupled to a second end 30 of a respective strap 12. The straps 12 are configured to be extended from the trunk 20 so that the shading module 14 is selectively positionable externally to the trunk 20, with the trunk 20 closed, as shown in FIG. 8. The shading module 14 is spring-loaded so that a center panel 32 of the shading module 14 is selectively extendable. The center panel 32 is configured to cover at least a portion of an upper surface 34 of the vehicle 22 to protect the portion of the upper surface 34 of the vehicle 22 from weather conditions and sunlight.

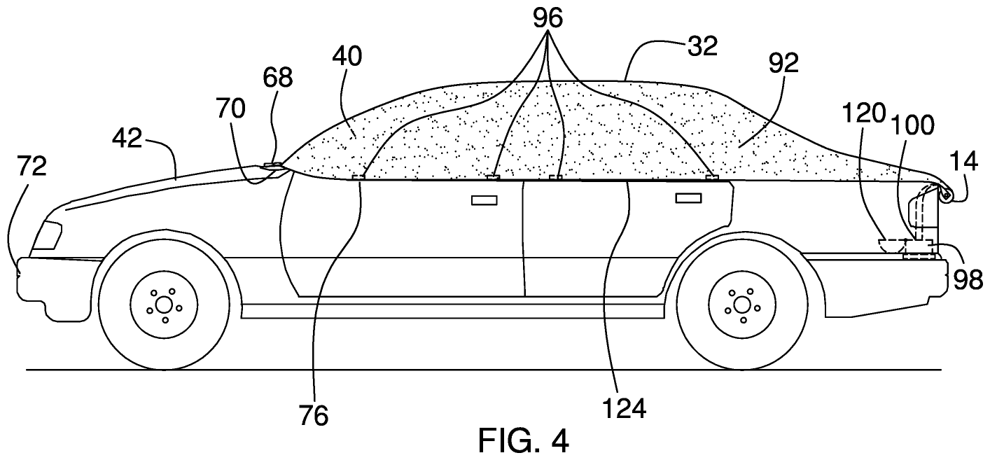

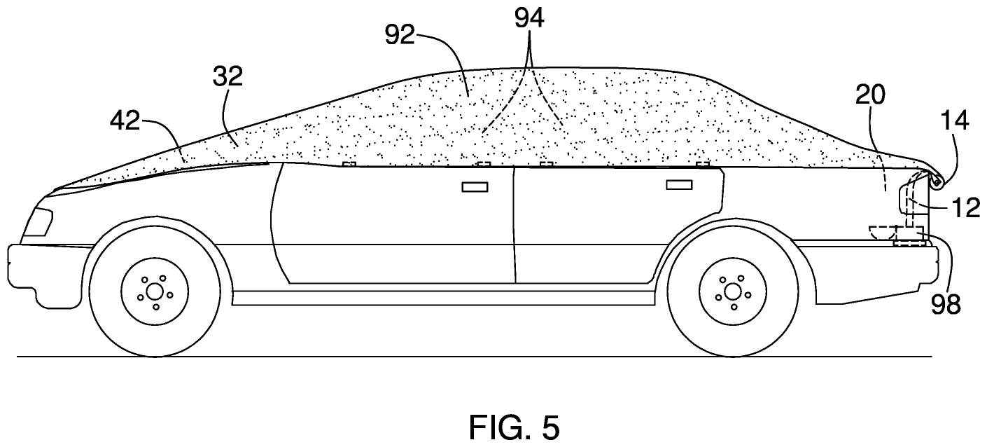

For example, in one situation where only a rear window 36 of the vehicle 22 would be directly exposed to the sun, a user may elect to extend the center panel 32 to cover the trunk 20 and the rear window 36 of the vehicle 22. In another situation, the user may elect to extend the center panel 32 to also cover a roof 38 and a front window 40 of the vehicle 22, as shown in FIG. 4. In yet another situation, the user may elect to further extend the center panel 32 to cover a hood 42 of the vehicle 22, as shown in FIG. 5. Preventing sunlight from entering a passenger compartment 44 of the vehicle 22 prevents high temperatures within the passenger compartment 44 and protects components of the passenger compartment 44 from damage by the sunlight, such as fading and drying. The center panel 32 also serves to protect the upper surface 34 from damage from sunlight and adverse weather conditions.

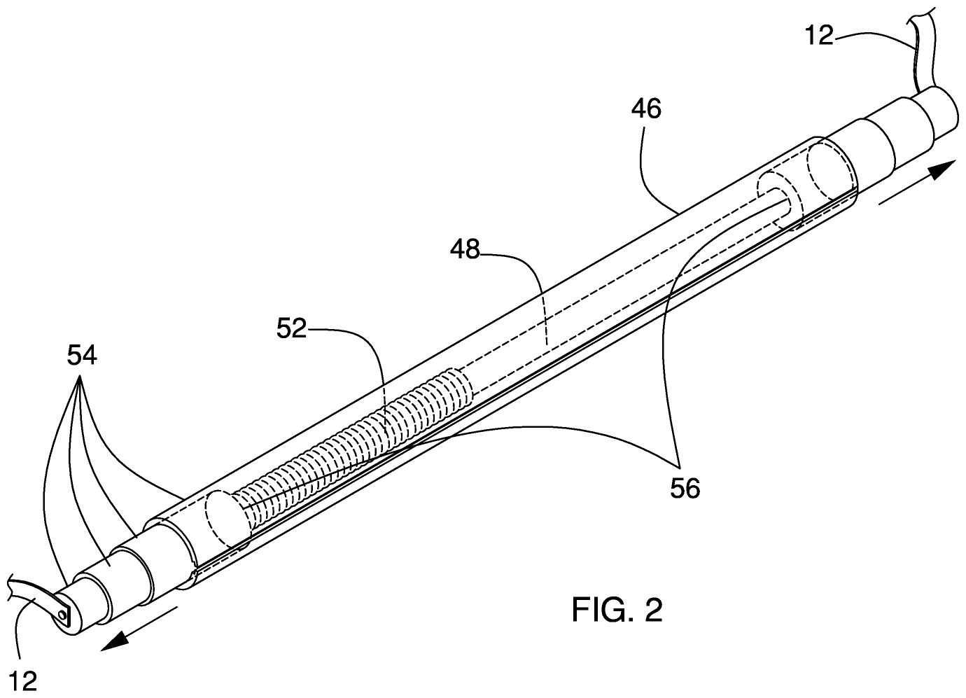

The components of extendible shades are well known to those skilled in the art. The present invention anticipates that any workable component combination can be used for the shading module 14. By way of non-limiting example, the shading module 14 comprises a tube 46, a rod 48, and a spring 50, as shown in FIG. 2. The center panel 32 is coupled by a first edge 52 to the tube 46. The tube 46 comprises a plurality of nested sections 54 so that the tube 46 is selectively extensible. The rod 48 is positioned in the tube 46. The spring 50 is coiledly positioned around and is coupled to the rod 48. The spring 50 also is coupled to the tube 46. One strap 12 of the pair of straps 12 is rotationally coupled to one opposing end 56 of the rod 48. The other strap 12 of the pair of straps 12 is fixedly coupled to the other opposing end 56 of the rod 48 so that the spring 50 is tensioned as the center panel 32 is unrolled from the tube 46 and so that the spring 50 is positioned to rebound to rotate the tube 46 to roll the center panel 32 onto the tube 46.

The shading module 14 also comprises a bar 58 and a handle 60. The bar 58 is coupled to a second edge 62 of the center panel 32. The handle 60 is coupled to the bar 58. The handle 60 is configured to be grasped in a hand of a user, positioning the user to pull on the handle 60 to extend the center panel 32 over at least the portion of the upper surface 34 of the vehicle 22. The bar 58 ensures that the center panel 32 unrolls evenly from the tube 46.

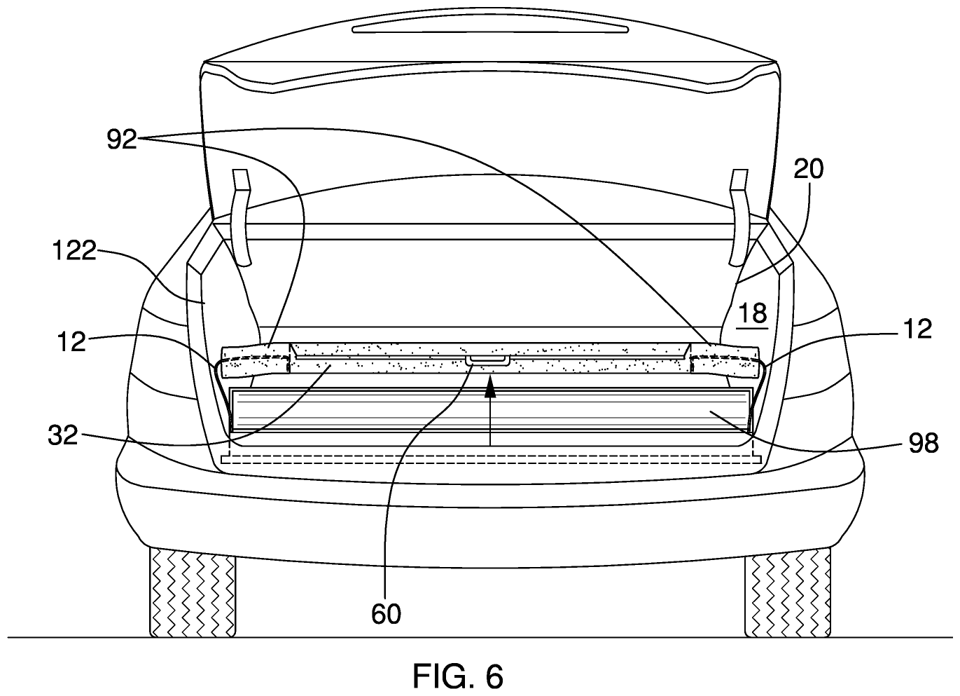

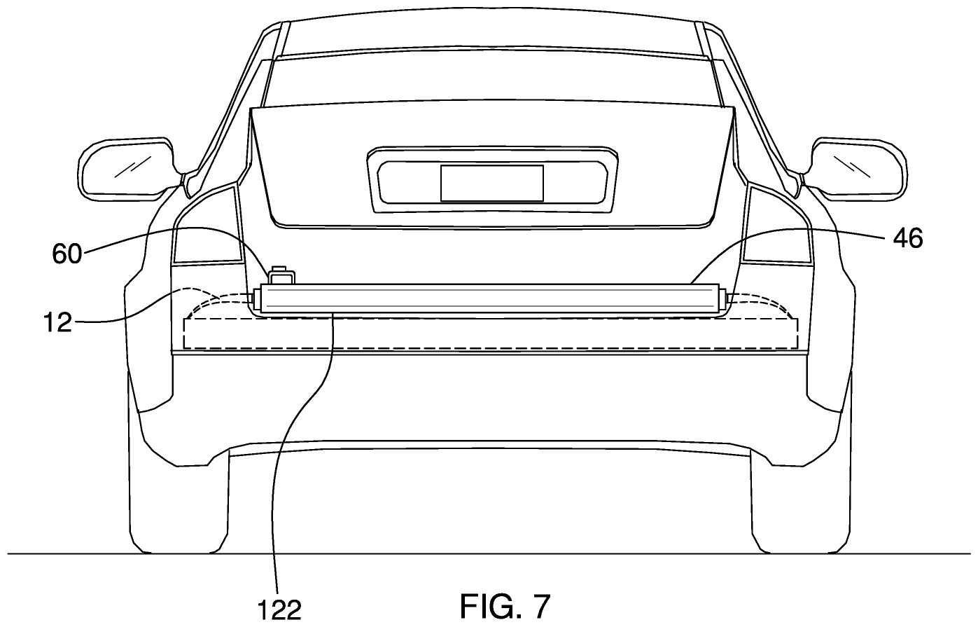

A channel 64 is positioned in the bar 58. The handle 60 is slidably positionable within the channel 64 so that the handle 60 is selectively positionable between opposing edges 66 of the center panel 32. The handle 60 being slidable relative to the bar 58 allows the handle 60 to be positioned as desired by the user. A user who is tall may elect to position the handle 60 substantially centered on the bar 58, as shown in FIG. 6, while a user who is shorter may elect to position the handle 60 proximate to a respective opposing edge 66 of the center panel 32, as shown in FIG. 7.

A hook 68 that is coupled to the handle 60 is configured to selectively couple to an element of the vehicle 22, such as a wiper housing 70, a bumper 72, and the hood 42, to fixedly position the center panel 32 over at least the portion of the upper surface 34 of the vehicle 22.

A plurality of center magnets 74 is coupled to the bar 58. The center magnets 74 are configured to selectively couple to a paramagnetic surface 76 of the vehicle 22, such as the hood 42 and the bumper 72, to fixedly position the center panel 32 over at least the portion of the upper surface 34 of the vehicle 22. Depending on the degree of extension of the center panel 32, either the hook 68 or the plurality of center magnets 74 are used to fixedly position the center panel 32.

A starter panel 78 is coupled to and is positioned between the center panel 32 and the tube 46. A slot 80 is positioned in the tube 46 so that the slot 80 is positioned to slidably insert a slat 82 that is coupled to a first endpoint 84 of the starter panel 78 to couple the starter panel 78 to the tube 46. A first fastener 86 is coupled to the starter panel 78 distal from the tube 46. A second fastener 88 is coupled to the first edge 52 of the center panel 32. The second fastener 88 is complementary to the first fastener 86. The second fastener 88 is positioned to selectively couple to the first fastener 86 to removably couple the center panel 32 to the starter panel 78. The second fastener 88 and the first fastener 86 comprises a hook and loop fastener 90. The center panel 32 being selectively couplable to the starter panel 78 allows for center panels 32 of different shapes, which correspond to differently shaped vehicles 22, to be coupled to the starter panel 78. Center panels 32 of varying colors and designs may also be attached to the starter panel 78 using the hook and loop fastener 90. The removable nature of the center panel 32 also allows for it to be cleaned.

Each of a pair of side panels 92 is coupled to and extends from a respective opposing edge 66 of the center panel 32. The side panel 92 is configured to position over at least a portion of an associated opposing side 26 of the vehicle 22 to cover a side window 94 that is positioned in the associated opposing side 26. The side panel 92 is tapered adjacent to each of the first edge 52 and the second edge 62 of the center panel 32 so that the pair of side panels 92 and the center panel 32 together are elongated octagon shaped.

The pair of side panels 92 and the center panel 32 comprise at least one of plastic, fabric, or the like, so that the pair of side panels 92 and the center panel 32 are flexible. The pair of side panels 92 and the center panel 32 comprise at least one of cotton, linen, hemp, polyester, nylon, polyether-polyurea copolymer, polypropylene, carbon black, titanium dioxide, zinc oxide, or the like, so that the pair of side panels 92 and the center panel 32 are configured to block at least one of ultraviolet radiation, airborne debris, rain, sleet, snow and hail.

Each of a plurality of panel magnets 96 is coupled to a respective side panel 92 proximate to a rim 124 of the respective side panel 92. The panel magnet 96 is configured to magnetically couple to the associated opposing side 26 of the vehicle 22 to removably couple the respective side panel 92 to the vehicle 22 to fixedly position the respective side panel 92 over the side window 94.

The assembly 10 also comprises a housing 98 that is configured to couple to the inner surface 18 of the trunk 20 of the vehicle 22 proximate to the rear 24 of the vehicle 22. The housing 98 has a top 100, which is open so that the top 100 is positioned to insert the shading module 14 into an interior space 102 that is defined by the housing 98.

The housing 98 comprises a base plate 104, a rear plate 106, and a front plate 108. The front plate 108 is coupled to and extends perpendicularly from a front edge 110 of the base plate 104. The rear plate 106 is coupled to and extends perpendicularly from a rear edge 112 of the base plate 104 so that the housing 98 is open-ended rectangularly box shaped. Being open-ended, the housing 98 is positioned to receive the rolled up center panel 32 with each side panel 92 being stowed between the housing 98 and the associated opposing side 26 of the vehicle 22. As the side panels 92 are flexible, they also can be folded over the center panel 32.

A plurality of holes 114 is positioned in the base plate 104. Each hole 114 is selectively alignable with a corresponding orifice (not shown) that is positioned in the trunk 20 of the vehicle 22. The hole 114 and the corresponding orifice are configured to insert a respective item of mounting hardware, not shown but may include a screw, a bolt, or the like, to couple the base plate 104 to the vehicle 22. The plurality of holes 114 comprises four holes 114 that are positioned singly proximate to each corner 116 of the base plate 104. The present invention also anticipates the use of other fastening means, which are obvious to those skilled in the art of fasteners, to fixedly position the base plate 104 within the trunk 20 of the vehicle 22. These other fastening means include, but are not limited to hook and loop fasteners, and, with the base plate 104 comprising metal, welding.

A recess 118 is positioned in the base plate 104. The recess 118 is arcuate so that the interior space 102 is substantially semicircularly shaped when viewed longitudinally. A lid 120 is hingedly coupled to the front plate 108 proximate to the top 100 of the housing 98. The lid 120 is semicircularly shaped when viewed longitudinally. The lid 120 is configured to pivot relative to the housing 98 to selectively close the top 100 to secure the shading module 14 within the housing 98.

In use, the trunk 20 is opened, and the shading module 14 is removed from the housing 98 so that the straps 12 extend over a lip 122 of the trunk 20. The trunk 20 then is closed to fixedly position the straps 12, which support the shading module 14. The handle 60 is grasped and pulled to selectively extend the center panel 32 over the trunk 20, the rear window 36, the roof 38, the front window 40, and the hood 42. Depending on the degree of extension of the center panel 32, either the hook 68 or the plurality of center magnets 74 are used to fixedly position the center panel 32. As the center panel 32 is being extended, the pair of side panels 92 fall into place over the opposing sides 26 of the vehicle 22 and the panel magnets 96 removably couple the side panels 92 to the vehicle 22.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A trunk mounted retractable sunshade assembly comprising:
a pair of straps, each strap having a first end configured for coupling to an inner surface of a trunk of a vehicle proximate to both a rear of the vehicle and a respective opposing side of the vehicle; and
a shading module having opposing endpoints, each opposing endpoint being coupled to a second end of a respective strap wherein the straps are configured for being extended from the trunk such that the shading module is selectively positionable externally to the trunk with the trunk closed, the shading module being spring-loaded such that a center panel of the shading module is selectively extendable wherein the center panel is configured for covering at least a portion of an upper surface of the vehicle to protect the portion of the upper surface of the vehicle from weather conditions and sunlight.

2. The assembly of claim 1, further including the shading module comprising:
a tube, the center panel being coupled by a first edge to the tube;
a rod positioned in the tube; and
a spring coiledly positioned around and coupled to the rod, the spring being coupled to the tube, one strap of the pair of straps being rotationally coupled to one opposing end of the rod, the other strap of the pair of straps being fixedly coupled to the other opposing end of the rod such that the spring is tensioned as the center panel is unrolled from the tube and such that the spring is positioned for rebounding for rotating the tube for rolling the center panel onto the tube.

3. The assembly of claim 2, further including the tube comprising a plurality of nested sections such that the tube is selectively extensible.

4. The assembly of claim 2, further comprising:
a bar coupled to a second edge of the center panel; and
a handle coupled to the bar wherein the handle is configured for grasping in a hand of a user positioning the user for pulling on the handle for extending the center panel over at least the portion of the upper surface of the vehicle.

5. The assembly of claim 4, further including a channel positioned in the bar, the handle being slidably positionable within the channel such that the handle is selectively positionable between opposing edges of the center panel.

6. The assembly of claim 4, further including a hook coupled to the handle wherein the hook is configured for selectively coupling to an element of the vehicle for fixedly positioning the center panel over at least the portion of the upper surface of the vehicle.

7. The assembly of claim 4, further including a plurality of center magnets coupled to the bar wherein the center magnets are configured for selectively coupling to a paramagnetic surface of the vehicle for fixedly positioning the center panel over at least the portion of the upper surface of the vehicle.

8. The assembly of claim 2, further comprising;
a starter panel coupled to and positioned between the center panel and the tube;
a first fastener coupled to the starter panel distal from the tube; and
a second fastener coupled to the first edge of the center panel, the second fastener being complementary to the first fastener wherein the second fastener is positioned for selectively coupling to the first fastener for removably coupling the center panel to the starter panel.

9. The assembly of claim 8, further including the second fastener and the first fastener comprising a hook and loop fastener.

10. The assembly of claim 8, further including a slot positioned in the tube such that the slot is positioned for slidably inserting a slat coupled to a first endpoint of the starter panel for coupling the starter panel to the tube.

11. The assembly of claim 2, further including a pair of side panels, each side panel being coupled to and extending from a respective opposing edge of the center panel wherein the side panel is configured for positioning over at least a portion of an associated opposing side of the vehicle for covering a side window positioned in the associated opposing side, the side panel being tapered adjacent to each of the first edge and the second edge of the center panel such that the pair of side panels and the center panel together are elongated octagon shaped.

12. The assembly of claim 11, further including the pair of side panels and the center panel comprising at least one of plastic and fabric such that the pair of side panels and the center panel are flexible.

13. The assembly of claim 12, further including the pair of side panels and the center panel comprising at least one of cotton, linen, hemp, polyester, nylon, polyether-polyurea copolymer, polypropylene, carbon black, titanium dioxide, and zinc oxide such that the pair of side panels and the center panel are configured for blocking at least one of ultraviolet radiation, airborne debris, rain, sleet, snow and hail.

14. The assembly of claim 11, further including a plurality of panel magnets, each panel magnet being coupled to a respective side panel proximate to a rim of the respective side panel wherein the panel magnet is configured for magnetically coupling to the associated opposing side of the vehicle for removably coupling the respective side panel to the vehicle for fixedly positioning the respective side panel over the side window.

15. The assembly of claim 1, further including a housing configured for coupling to the inner surface of a trunk of the vehicle proximate to the rear of the vehicle, the housing having a top, the top being open such that the top is positioned for inserting the shading module into an interior space defined by the housing.

16. The assembly of claim 15, further including the housing comprising a base plate, a rear plate, and a front plate, the front plate being coupled to and extending perpendicularly from a front edge of the base plate, the rear plate being coupled to and extending perpendicularly from a rear edge of the base plate such that the housing is open-ended rectangularly box shaped.

17. The assembly of claim 16, further including a plurality of holes positioned in the base plate, each hole being selectively alignable with a corresponding orifice positioned in the trunk of the vehicle wherein the hole and the corresponding orifice are configured for inserting a respective item of mounting hardware for coupling the base plate to the vehicle, the plurality of holes comprising four holes positioned singly proximate to each corner of the base plate.

18. The assembly of claim 16, further comprising:
a recess positioned in the base plate, the recess being arcuate such that the interior space is substantially semicircularly shaped when viewed longitudinally; and
a lid hingedly coupled to the front plate proximate to the top of the housing, the lid being semicircularly shaped when viewed longitudinally wherein the lid is configured for pivoting relative to the housing for selectively closing the top for securing the shading module within the housing.

19. A vehicle and trunk mounted retractable sunshade assembly combination comprising:
a vehicle;
a pair of straps, each strap having a first end coupled to an inner surface of a trunk of the vehicle proximate to both a rear of the vehicle and a respective opposing side of the vehicle; and
a shading module having opposing endpoints, each opposing endpoint being coupled to a second end of a respective strap wherein the straps are configured for being extended from the trunk such that the shading module is selectively positionable externally to the trunk with the trunk closed, the shading module being spring-loaded such that a center panel of the shading module is selectively extendable for covering at least a portion of an upper surface of the vehicle to protect the portion of the upper surface of the vehicle from weather conditions and sunlight.

20. A trunk mounted retractable sunshade assembly comprising:
a pair of straps, each strap having a first end configured for coupling to an inner surface of a trunk of a vehicle proximate to both a rear of the vehicle and a respective opposing side of the vehicle;
a shading module having opposing endpoints, each opposing endpoint being coupled to a second end of a respective strap wherein the straps are configured for being extended from the trunk such that the shading module is selectively positionable externally to the trunk with the trunk closed, the shading module being spring-loaded such that a center panel of the shading module is selectively extendable wherein the center panel is configured for covering at least a portion of an upper surface of the vehicle to protect the portion of the upper surface of the vehicle from weather conditions and sunlight, the shading module comprising:
a tube, the center panel being coupled by a first edge to the tube, the tube comprising a plurality of nested sections such that the tube is selectively extensible,
a rod positioned in the tube,
a spring coiledly positioned around and coupled to the rod, the spring being coupled to the tube, one strap of the pair of straps being rotationally coupled to one opposing end of the rod, the other strap of the pair of straps being fixedly coupled to the other opposing end of the rod such that the spring is tensioned as the center panel is unrolled from the tube and such that the spring is positioned for rebounding for rotating the tube for rolling the center panel onto the tube,
a bar coupled to a second edge of the center panel,
a handle coupled to the bar wherein the handle is configured for grasping in a hand of a user positioning the user for pulling on the handle for extending the center panel over at least the portion of the upper surface of the vehicle,
a channel positioned in the bar, the handle being slidably positionable within the channel such that the handle is selectively positionable between opposing edges of the center panel,
a hook coupled to the handle wherein the hook is configured for selectively coupling to an element of the vehicle for fixedly positioning the center panel over at least the portion of the upper surface of the vehicle,
a plurality of center magnets coupled to the bar wherein the center magnets are configured for selectively coupling to a paramagnetic surface of the vehicle for fixedly positioning the center panel over at least the portion of the upper surface of the vehicle,
a starter panel coupled to and positioned between the center panel and the tube,
a first fastener coupled to the starter panel distal from the tube, a second fastener coupled to the first edge of the center panel, the second fastener being complementary to the first fastener wherein the second fastener is positioned for selectively coupling to the first fastener for removably coupling the center panel to the starter panel, the second fastener and the first fastener comprising a hook and loop fastener,
a slot positioned in the tube such that the slot is positioned for slidably inserting a slat coupled to a first endpoint of the starter panel for coupling the starter panel to the tube,
a pair of side panels, each side panel being coupled to and extending from a respective opposing edge of the center panel wherein the side panel is configured for positioning over at least a portion of an associated opposing side of the vehicle for covering a side window positioned in the associated opposing side, the side panel being tapered adjacent to each of the first edge and the second edge of the center panel such that the pair of side panels and the center panel together are elongated octagon shaped, the pair of side panels and the center panel comprising at least one of plastic and fabric such that the pair of side panels and the center panel are flexible, the pair of side panels and the center panel comprising at least one of cotton, linen, hemp, polyester, nylon, polyether-polyurea copolymer, polypropylene, carbon black, titanium dioxide, and zinc oxide such that the pair of side panels and the center panel are configured for blocking at least one of ultraviolet radiation, airborne debris, rain, sleet, snow and hail, and
a plurality of panel magnets, each panel magnet being coupled to a respective side panel proximate to a rim of the respective side panel wherein the panel magnet is configured for magnetically coupling to the associated opposing side of the vehicle for removably coupling the respective side panel to the vehicle for fixedly positioning the respective side panel over the side window;
a housing configured for coupling to the inner surface of the trunk of the vehicle proximate to the rear of the vehicle, the housing having a top, the top being open such that the top is positioned for inserting the shading module into an interior space defined by the housing, the housing comprising a base plate, a rear plate, and a front plate, the front plate being coupled to and extending perpendicularly from a front edge of the base plate, the rear plate being coupled to and extending perpendicularly from a rear edge of the base plate such that the housing is open-ended rectangularly box shaped;
a plurality of holes positioned in the base plate, each hole being selectively alignable with a corresponding orifice positioned in the trunk of the vehicle wherein the hole and the corresponding orifice are configured for inserting a respective item of mounting hardware for coupling the base plate to the vehicle, the plurality of holes comprising four holes positioned singly proximate to each corner of the base plate;
a recess positioned in the base plate, the recess being arcuate such that the interior space is substantially semicircularly shaped when viewed longitudinally; and
a lid hingedly coupled to the front plate proximate to the top of the housing, the lid being semicircularly shaped when viewed longitudinally wherein the lid is configured for pivoting relative to the housing for selectively closing the top for securing the shading module within the housing.
